(19) United States
(12) Patent Application Publication
(10) Pub. No.: US 2017/0365019 A1
(43) Pub. Date: Dec. 21, 2017

(54) Method and System for Searching Real Estate Information

(71) Applicant: Guobin HE, San Diego, CA (US)

(72) Inventor: Guobin HE, San Diego, CA (US)

(21) Appl. No.: 15/624,557

(22) Filed: Jun. 15, 2017

Related U.S. Application Data
(60) Provisional application No. 62/351,874, filed on Jun. 17, 2016.

(30) Foreign Application Priority Data
Feb. 6, 2017 (CN) 201710066118.8

(51) Int. Cl. G06Q 50/16; G06F 17/30

(52) U.S. Cl. CPC G06Q 50/16; G06F 17/30991; G06F 17/30241; G06F 17/30867

(57) ABSTRACT

A method of searching real estate information of a property for a search engine. The method includes the steps of: processing, by a computing system, a first set of transmissions from an end-user device and received by a server system, the first set of transmissions including a real estate search request of the property including Structural Features, Surrounding Neighborhood Features, and Relevant Proximity Features of the property to one or more real estate features stored in a real estate database; processing information, by the computing system, the Structural Features, the Surrounding Neighborhood Features, and the Relevant Proximity Features of the property for each search suggestion, and identifying one or more properties by the Structural Features, the Surrounding Neighborhood Features, and the Relevant Proximity Features of the property, and stores the search suggestions to a real estate database; receiving and parsing, by the computing system, the real estate search request to obtain a search query, and comparing the search query at least partially based on the real estate search request; and comparing, by the computing system, the search query to a default search query in the real estate database, and obtaining the results of a target property corresponding to the search query.

### CROSS-REFERENCE TO RELATED APPLICATIONS

This application claims priority to a U.S. Provisional Application Ser. No. 62/351,874 filed on Jun. 17, 2016, and Chinese Application No. 201710066118.8 having an application date of Feb. 6, 2017, both of which are hereby incorporated by reference in their entireties.

### COPYRIGHT NOTICE

One or more portions of this disclosure contain material which is subject to copyright protection. The copyright owner makes no objection to reproduction by anyone of this disclosure as disclosed in the Patent and Trademark Office files, record, or the like. Otherwise, the copyright owner reserves any and all copyright rights whatsoever for this patent disclosure. 37 CFR 1.71(d).

### BACKGROUND OF THE DISCLOSURE

### (1) Field of the Disclosure

The field of the disclosure relates to the technical field of Internet information services, and more particularly to real estate information searching method and system.

### (2) Description of Related Art Including Information Disclosed Under 37 CFR 1.97 and 1.98

Real estate buying and selling has become one of the necessities of life. More and more people are actively engaged and wish to improve their standard of living. People want real estate choices, and their personal requirements are growing. Real estate buyers and sellers alike would like to consider easily the location of property, surroundings, the floor plan of the property and other conditions. The use of the Internet greatly facilitates real estate searches. People who like to sell, buy or rent real estate are more inclined to use Internet or mobile terminal applications.

When seeking information about real estate, people ordinarily use Internet real estate search sites that include real estate information with geographic information, such as city, zip code and so on. User search conditions include fill-in selection variables such as property type, price, square footage, number of bedrooms, number of bathrooms, total property area, and distance to schools.

The real estate search site returns a list of real estate listings in accordance with search conditions. Using known real estate searching websites, the user can add or change search conditions to further refine their search. When the user clicks or chooses a real estate listing in a real estate search website, the real estate website will display details of the property.

The details of the property include photos, virtual property tours and other specific information, such as quick profiles, floor plans, community areas, and interior and exterior decoration features, all of which help users better understand the property and its surrounding.

Many real estate websites provide further information for the property searched including historical transaction records, public information, and school district letters so that the user can make a better decision.

However, for some population of users, the above information is not enough.

Therefore, in view of the above, there is a need for a method and system that searches real estate information and provides further information in a cost-efficient fashion and alerts a user about additional issues that may be of interest to a particular group of users.

### BRIEF SUMMARY OF THE DISCLOSURE

The disclosure herein addresses and overcomes some if not all the above-described drawbacks of conventional real estate search engines and systems. In view of the above, the present disclosure provides a method and a system for searching real estate information to accommodate consumers who are believers in the Five Arts of Chinese Metaphysics, including but not limited to Feng Shui, Chinese astronomy, and the study of energy forces “Qi.” In one embodiment, the disclosed system allows a user to perform a search in view of elements pertinent to the Five Arts of Chinese Metaphysics. In another embodiment, the disclosed system allows a user to interact with the system to learn about pertinent issues related to a particular property. In a further embodiment, the contemplated system provides a cost-effective way to educate a user in specific issues violating the Five Arts of Chinese Metaphysics pertaining to a particular real estate property. In yet another embodiment, the contemplated system provides a revenue-generation model involving users and third party vendors.

Advantageously, using the disclosed system and method as part of the real estate search will enable users to take into account factors specifically and individually important to them.

In one aspect, a contemplated method includes the steps of:

processing, by a computing system, a first set of transmissions from an end-user device and received by a server system, the first set of transmissions including a real estate search request of the property including Structural Features, Surrounding Neighborhood Features, and Relevant Proximity Features of the property to one or more real estate features stored in a real estate database;

processing information, by the computing system, the Structural Features, the Surrounding Neighborhood Features, and the Relevant Proximity Features of the property for each search suggestion, and identifying one or more properties by the Structural Features, the Surrounding Neighborhood Features, and the Relevant Proximity Features of the property, and stores the search suggestions to a real estate database;

receiving and parsing, by the computing system, the real estate search request to obtain a search query, and comparing the search query at least partially based on the real estate search request; and

Comparing, by the computing system, the search query to a default search query in the real estate database, and obtaining the results of a target property corresponding to the search query.

In one aspect, a system searches for searching real estate information of a property for a search engine. In this system,

a server system comprising one or more servers communicatively coupled to one or more network interfaces to facilitate access to a network, the server system comprising one or more data stores communicatively coupled to the one or more servers, the one or more data stores storing candidate data for searching real estate information, the one or more servers to:

process transmissions collected by a collecting device and received by the server system, the transmissions are received from an end-user interface as user input for a search device;

display the transmissions on a display device;

display the transmissions on a real estate information display device; and

create an evaluation report display device;

wherein, the server is connected to a real estate search request for the search engine for searching for real estate information, collecting Structural Features, Surrounding Neighborhood Features, and Relevant Proximity Features of a property, wherein the search query is compared to data stored in a real estate database;

wherein the search suggestions for the search engine is connected to the transmissions that are collected to search suggestions, set the Structural Features, Surrounding Neighborhood Features, and Relevant Proximity Features of the property, and storing search query to the real estate database;

It is to be understood that both the foregoing general description and the following detailed description are exemplary and are provided for purposes of explanation only, and are not restrictive with respect to the claimed subject matter. Further features and advantages will become more fully apparent in the following description of the preferred embodiments and from the appended claims.

Various objects, features, aspects and advantages of the present disclosure will become more apparent from the following detailed description of preferred embodiments of the disclosure, along with the accompanying drawings in which like numerals represent like components.

All referenced patents, applications and literatures are incorporated herein by reference in their entirety.

Furthermore, where a definition or use of a term in a reference, which is incorporated by reference herein, is inconsistent or contrary to the definition of that term provided herein, the definition of that term provided herein applies and the definition of that term in the reference does not apply.

The disclosure may seek to satisfy one or more of the above-mentioned desires. Although the present disclosure may obviate one or more of the above-mentioned desires, it should be understood that some aspects of the disclosure might not necessarily obviate them.

### BRIEF DESCRIPTION OF THE DRAWINGS

It should be noted that the drawing figures may be in simplified form and might not be to precise scale. In reference to the disclosure herein, for purposes of convenience and clarity only, directional terms, such as, top, bottom, left, right, up, down, over, above, below, beneath, rear, front, distal, and proximal are used with respect to the accompanying drawings. Such directional terms should not be construed to limit the scope of the disclosure in any manner.

Description of the drawings is incorporated in the specification and constitutes a part of the specification; the accompanying drawings illustrate the practice of the disclosure, and, together with its description, serve to explain the principles of the disclosure.

FIG. 1 is a flow chart of a method of searching for real estate information as described in the first embodiment of the present disclosure.

FIG. 2 is a flow chart of a method of searching for real estate information as described in the second embodiment of the present disclosure.

FIG. 3 is a schematic structural view of a system for searching real estate information as described in the third embodiment of the present disclosure.

FIG. 4 is a schematic diagram of application architecture for searching for real estate information as described in the first embodiment of the present disclosure.

FIG. 5 shows the three major categories of elements contemplated: Structural Features, Surrounding Neighborhood Features, and Relevant Proximity Features of real estate properties in the first embodiment of the present disclosure.

FIG. 6 is a schematic diagram showing a specific application of the method for searching for real estate information in the second embodiment of the present disclosure.

FIG. 7 is a schematic view showing a real estate orientation definition mode in another embodiment of the present disclosure.

FIG. 8 is a view showing examples of available fields of filtering to refine a search.

FIG. 9A is schematic view showing a search result in one embodiment of the present disclosure.

FIG. 9B is a schematic view showing detail information of Relevant Proximity Features on a particular real estate property in one embodiment of the present disclosure.

FIG. 9C is an illustration, in the form of a map, of Relevant Proximity Features on a particular real estate property in one embodiment of the present disclosure.

FIG. 10 is a specific example view of a questionnaire in an embodiment of the present disclosure.

FIG. 11 is an interface showing a list of experts that the user may contact, in one embodiment of the present disclosure.

FIG. 12 shows a functional system diagram illustrating mobile software application and system according to an embodiment of the present disclosure.

FIG. 13 illustrates a block diagram of a processing system illustrating interaction between mobile software application, system, and mobile device, according to an embodiment of the present disclosure of FIG. 12.

### DETAILED DESCRIPTION OF THE DISCLOSURE

The disclosure and its various embodiments can now be better understood by turning to the following detailed description of the preferred embodiments, which are presented as illustrated examples of the disclosure. It is expressly understood that the disclosure may be broader than the illustrated embodiments described below.

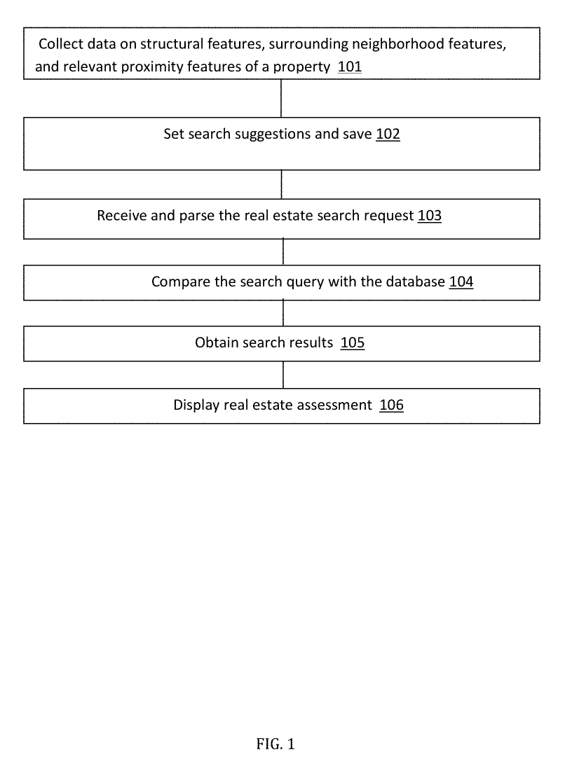

FIG. 1 shows the flow chart of one contemplated method for searching the real estate information described in the present embodiment and comprises the steps of:

In step 101, for a property (real estate property), the system collects data on the following three categories: Structural Features of the specific property, Surrounding Neighborhood Features of the specific property, and Relevant Proximity Features of the specific property.

In one embodiment, data collection is done by a machine automatically by existing methods, especially where such data is available in a public database.

In another embodiment, certain data can be manually entered by at least one of the following persons: home owner, seller's agent, buyer's agent, buyer, potential buyer, system administrator, any user of the contemplated search device, and a member of the public.

In yet another embodiment, certain data fields are purposely left unanswered, and a user may be required to enter those data fields for a particular real estate property. Further, in other embodiments, the data enter by the user may not be saved in the database of the system for other users to see.

As used herein, the category “Structural Features” in conjunction with a particular real estate property refers specifically to at least the following physical aspects of a particular real estate property: the location and orientation of the staircase, the front door, the back door, the bathroom door, and a mirror, with respect to their spatial orientation relative to each other or to another. Also included can be a direction the front door faces (e.g., north or south). In one embodiment, “Structural Features” includes only the following physical aspects of a particular real estate property: the location and orientation of the staircase, the front door, the back door, the bathroom door, and a mirror with respect to their spatial orientation relative to each other or to another, and a direction the front door faces (e.g., north or south). It should be noted that common search fields already being used in real estate search engine are specifically excluded from this category. These common search fields include, and are not limited to, the following: number of bedrooms, number of floors, number of bathrooms, square footage.

As used herein, the category “Surrounding Neighborhood Features” in conjunction with a particular real estate property refers specifically to at least one from the following aspects on the immediate vicinity of a particular real estate property: the existence and orientation of a sloped backyard, a T-intersection/junction, a cul-de-sac, and their spatial orientation to the target property. In one embodiment, the category “Surrounding Neighborhood Features” can only include the existence and orientation of a sloped backyard, a T-intersection/junction, a cul-de-sac, and their spatial orientation to the target property. It should be noted that common search fields about a property's neighborhood already being used in real estate search engine are specifically excluded from this category. These common search fields include, and are not limited to, the following: square footage of a yard, existence of a swimming pool, existence of a home owners association.

As used herein, the category “Surrounding Neighborhood Features” in conjunction with a particular real estate property refers specifically to at least one from the following aspects of the immediate vicinity of a particular real estate property: (a) the existence and orientation of a sloped backyard, a T-intersection/junction, a cul-de-sac, and their spatial orientation to the target property, and their directional orientation to the North Pole, and/or (b) the directional orientation of the front door relative to the North Pole. In one embodiment, the category “Surrounding Neighborhood Features” can only include (a) the existence and orientation of a sloped backyard, a T-intersection/junction, a cul-de-sac, and their spatial orientation to the target property, and their directional orientation to the North Pole, and/or (b) the directional orientation of the front door relative to the North Pole. It should be noted that common search fields about a property's neighborhood already being used in real estate search engine are specifically excluded from this category. These common search fields include, and are not limited to, the following: square footage of a yard, existence of a swimming pool, existence of a home owners association.

As used herein, the category “Relevant Proximity Features” in conjunction with a particular real estate property refers specifically to at least one from the following aspects of a particular real estate property: the proximity and/or distance to the following physical elements—a railway, a cemetery, a church, a temple, a fire station, a police station, a hospital, a cell phone tower, and a power line transmission tower. In one embodiment, this category can only include at least one selected from the following aspects of a particular real estate property: the proximity and/or distance to the following physical elements—a railway, a cemetery, a church, a temple, a fire station, a police station, a hospital, a cell phone tower, and a power line transmission tower. It should be noted that while the existence of any of the above establishments are currently known to be shown on maps or in the description of a real estate property listing, there is currently no available search engines that can sort, search, and/or display search results based on the proximity/distance of these establishments relative to the target real estate property.

As used herein, the “real estate database” is referred to a proprietary database having data relating to the above three categories. The real estate database is maintained by the contemplated system.

In step 102, the system sets search suggestions based on data in the Structural Features, Surrounding Neighborhood Features, and Relevant Proximity Features of one or more real estate property in a real estate database. Optionally, the system provides search suggestions when a user began to type in a search query. The system saves the search suggestions to the real estate database.

In step 103, the system receives and parses the real estate search request/query, and compares the search query with the real estate database. It then displays the search query corresponding to the real estate search request.

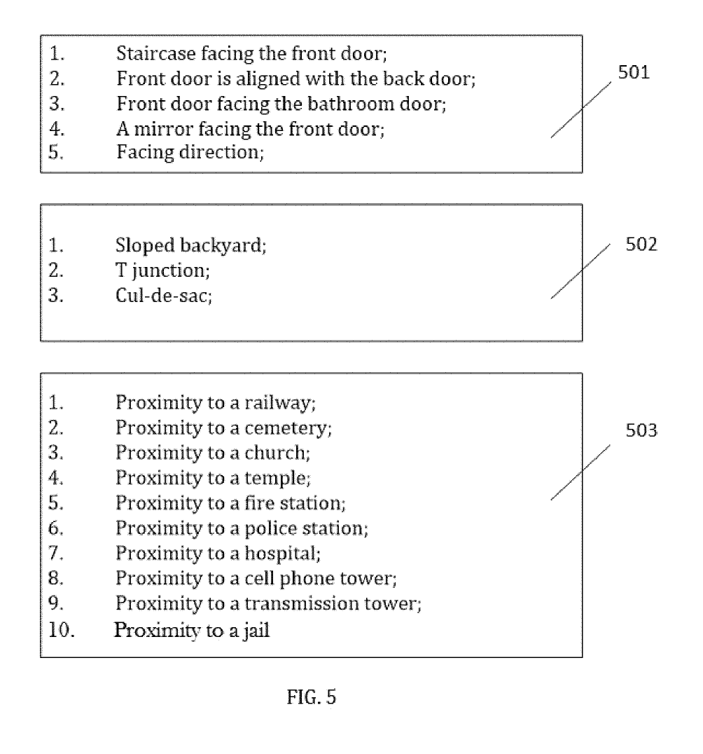

FIG. 5 illustrates the Structural Features, the Surrounding Neighborhood Features, and Relevant Proximity Features to each specific real estate property/target property.

In a first category, “Structural Features” of the target property are collected. For example, whether a front door is facing a bathroom door, or if a mirror is facing a front door (see 501).

In a second category, Surrounding Neighborhood Features of the target property is considered. For example, whether there is a sloped backyard, if the real estate property is located at the juncture of a T-intersection/junction or a cul-de-sac, the facing direction (e.g., north or south) of the property, or if the house have a sloped backyard (see 502).

In a third category, Relevant Proximity Features including the distance from certain kinds of establishments or locations from the target property. Advantageously, users can set their own criteria for this distance or use a default setting. Additionally, there are different Relevant Proximity Features rules for each user.

In one example, if the distance to the target property from one or more specific establishments or locations is too close based on a user criteria in a real estate search request, e.g., a fire station or a police station or a school, in a property surroundings report, this property may be considered an undesirable, i.e., bad, real estate for the user.

On the other hand, undesirable conditions for one user may be a good location for another user, e.g., a particular fireman or policeman or parent may want to live near a fire or police station or school so that it is more convenient for them to go to work or drop off their child. Other users may feel that same property is an undesirable because of traffic (school buses and parent cars) or noise from sirens from these one or more specific establishments or locations (see 503).

The one or more specific establishments and locations may include any or all the following: train lanes, train crossings, jails, funeral parlors, churches, temples, fire stations, police stations, schools, hospitals, signal towers, cell phone stations and so on.

In summary, the first category of the Structural Features, the second category of Surrounding Neighborhood Features, and the third category of the Relevant Proximity Features are shown in the real estate search interface and in a specific real estate search interface.

Advantageously, the above mentioned three real estate categories are used in the real estate assessment when evaluating a target property for households and are provided as part of a real estate evaluation report.

In step 104 of FIG. 1, according to details of the target property display request, the system compares and displays selected search query with one or more real estate features of the Structural Features, Surrounding Neighborhood Features, and comparison with the search query suggestions of a similar content target property.

In step 105, according to the details of the target property display request from the real estate database, the system obtains the search results including the Structural Features, Surrounding Neighborhood Features, and Relevant Proximity Features of the target property and details are displayed on a display device.

Step 106, according to a real estate assessment request, the system collects and compares real estate assessments of target property real estate information with a real estate assessment standard to generate a target assessment report of the target property. For example, it is generated according to a request received for a real estate assessment report of the target property by a user, who could be, a real estate assessment expert.

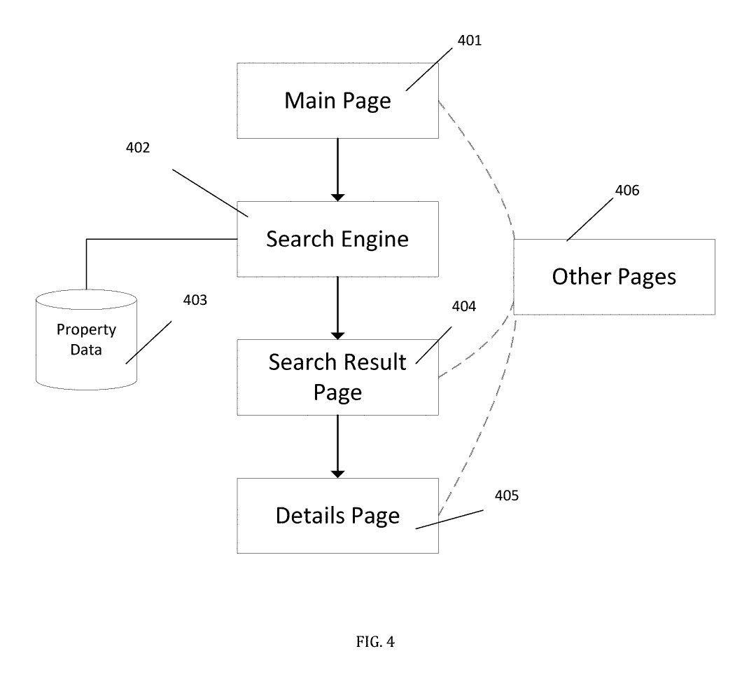

As shown in FIG. 4 shows the application framework that searches the real estate information as described in the present embodiment.

The first step shows that a user enters the search query on the Main Page 401 (real estate search website) and then clicks the Search Engine 402 (real estate search website).

To process the search query, the user finds the matching real estate in the Property Data 403 (real estate database) and generates Search Result Page 404 (real estate search result page).

The search results are arranged in a certain order, and the order may be based on the degree of importance of the preset (user chosen property preferences or conditions) or on the word order. In this search results page, each property has only one or two items of important information listed.

The user can add exclusion options (filter options) to further refine the search results when obtaining the Details Page 405 (details of the search results).

Simultaneously in the application architecture, there are Other Pages 406. Other Pages may include: advertisement pages, search query adjustment pages, real estate display pages, and so on.

Advantageously, according to the real estate search method described in the present embodiment, users can, according to their own preference for the real estate in view of the study of Feng Shui and the Five Arts of Chinese Metaphysics, conduct a search in the real estate search interface using searching features specific to such studies. Users can input important characteristics (user chosen property preference or conditions as presets) to include in the query standard. In one example, a user can query properties in an area without a slopped backyard where the single faces south.

In another example, a user can exclude all properties (real estate) less than a half mile from a mobile phone base station. The system provides more convenient and accurate guidance regarding the surrounding when the user is choosing a property.

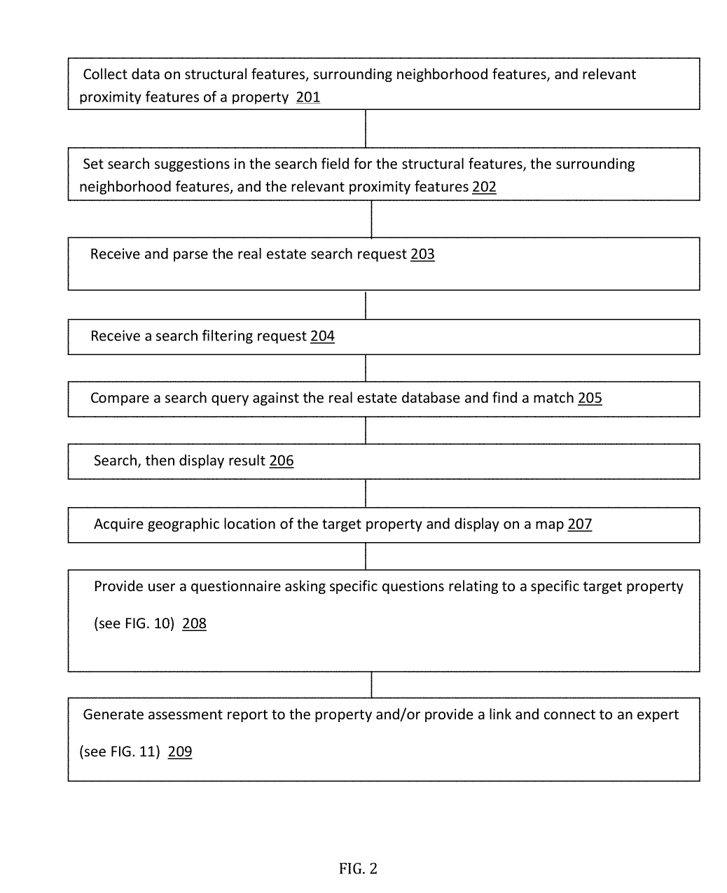

FIG. 2 shows, a flow chart of a method for searching real estate information as described in the present embodiment.

In addition to the embodiment of FIG. 1, the search filtering request, the map display, and the real estate are described, as are the specific contents of a search query.

The method described in the present embodiment comprises the steps of:

In step 201, in the system for searching the real estate information, the Structural Features, Surrounding Neighborhood Features, and Relevant Proximity Features of the property is collected, this information is stored in the real estate database.

The Structural Features include one or more of the following: a property orientation, a staircase orientation, a relationship between a door and a back door, an orientation of a front door and a toilet door, and an orientation of a front door and a mirror.

The Surrounding Neighborhood Features includes one or more of the following: street type (cul-de-sac or T-bone) characteristic, characteristic and/or backyard slope characteristic.

The Relevant Proximity Features include a distance from the property to one or more specific establishments or locations includes one or more of the following: train station, train track, jail, a funeral parlor, a hall, church, temple, fire station, police station, hospital, signal tower or mobile phone signal station.

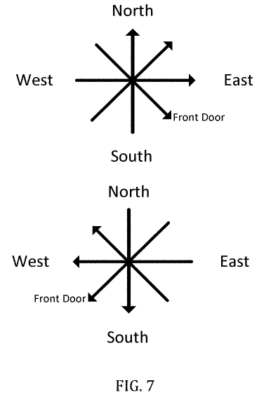

FIG. 7 is a schematic view showing a real estate orientation definition mode in the second embodiment of the present disclosure.

Referring to FIG. 7, the arrow shows the direction the front door is facing the direction. There are eight basic orientations: south, north, east, toward, west, northwest, northeast, southwest, and southeast. The direction of the property can be ascertained manually or can be generated based on a calculation program.

In some embodiments, an orientation of the property can be determined by the orientation of the front door. For example, if a front door is on a side of the property, it could be determined that front is actually facing a parking lot or a backyard.

On the other hand, when determining the orientation of the property, if there is no real estate in front of a parking lane or backyard, the direction of the property would be more difficult to determine. In this case, on the search results page, a user can follow the clockwise direction of the property or counterclockwise to obtain an arrangement of the property.

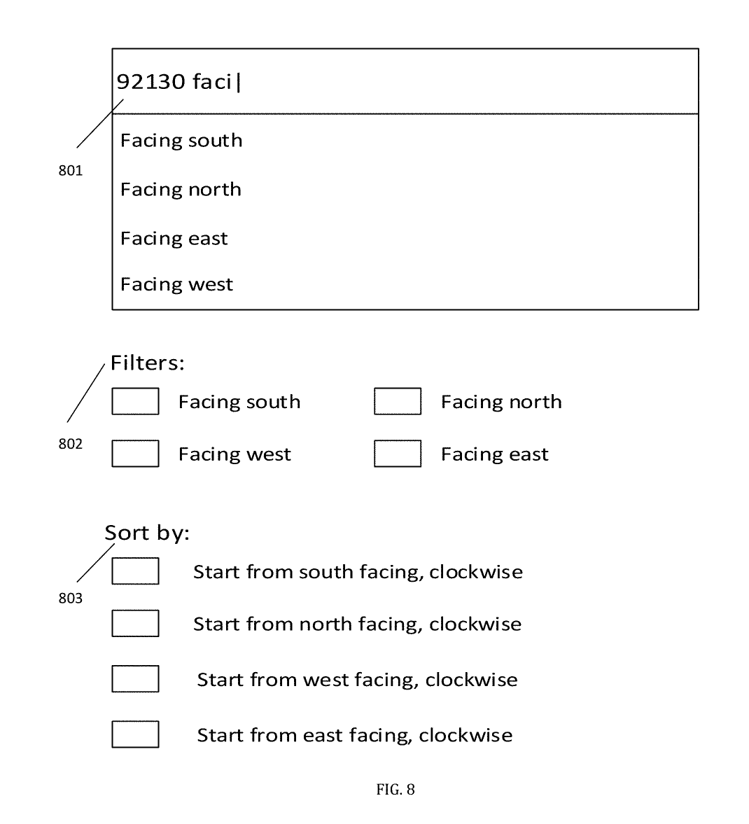

FIG. 8 is a view showing a zip code area in which a search is performed based on a user's physical preference in the second embodiment of the present disclosure.

Referring to FIG. 8, the structure of the real estate search based on the user's preference is shown. When a user enters a search keyword in an input box 801, the system displays a suggestion Option to help the user complete the input.

In further explanation, as a user starts to enter the search keywords, the drop-down window shows the suggested options: south, and so on. If suggested options and user search are consistent, the user can select one of the suggested options. The same will occur when the user wants to refine it or use exclusions (filters) when conducting the search.

When a user enters the postal code regarding a new search, as the search results are obtained, the user can open the lookup selection box 802 to exclude (filters) an item to refine his search. Further, by using the sort selection box 803 the user can select the sorted form of the property. More specifically as illustrated in 803, further search results show all the property in the southbound range within this zip code.

Referring again to FIG. 2. In step 202, the search suggestions are generated in advance and stored in the database for each of the three categories: Structural Features, Surrounding Neighborhood Features, and Relevant Proximity Features. This can facilitate a user when he or she types in a query.

In step 203, the system receives and parses the real estate search request to obtain a search query; the content of the real estate search request is compared with the search query in the real estate database, and the search query corresponding to the real estate search request are displayed on a display device.

In step 204, the system receives a search filtering request for the search query, and presenting and displaying all of the search suggestions; the search suggestions of the target property that illustrates the specific contents of the target property and the Structural Features, Surrounding Neighborhood Features, and Relevant Proximity Features of the one or more real estate features in the real estate database of the target property that all of which have the same content as the search suggestions of the target property, and then displays them on a display device.

In step 205, the system compares the search request with one or more real estate features of the Structural Features, Surrounding Neighborhood Features, and Relevant Proximity Features in the real estate database. Data in the real estate surrounding Structural Features, Surrounding Neighborhood Features, and Relevant Proximity Features are compared with the real estate search request.

In step 206, the system searches the real estate database based on details of the structure features, Surrounding Neighborhood Features, and Relevant Proximity Features and displays the results on the display device.

In step 207, the geographic location of a target property is acquired and displayed on a map.

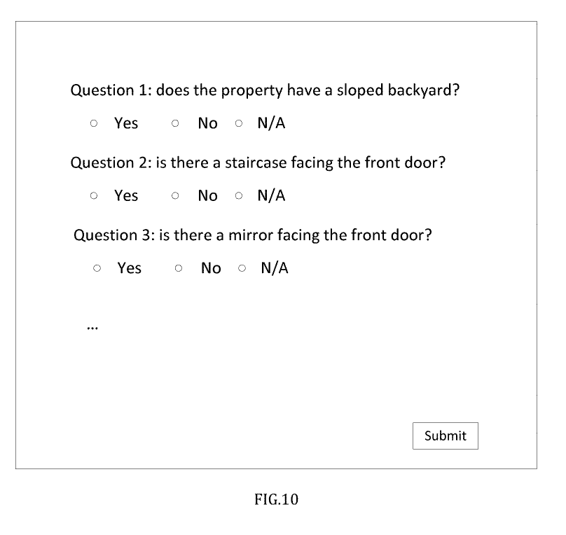

In step 208, for each of the Structural Features, Surrounding Neighborhood Features, and Relevant Proximity Features, of the target property, the details of the Structural Features, Surrounding Neighborhood Features, and Relevant Proximity Features of the specific establishments or locations are saved to the real estate database. A user is provided a questionnaire to ask specific questions relating to a specific house, e.g., FIG. 10.

Advantageously, the system determines and saves assessment data to the real estate database. The system then obtains a property from the real estate database pursuant to a request for real estate property assessment data by a user and displays it on a display device.

In Step 209, according to a real estate assessment request, show the real estate assessment of the information collection section, the real estate information collected is compared with a standard real estate assessment, which generates a target of the real estate assessment report of the property and displays it on a display device.

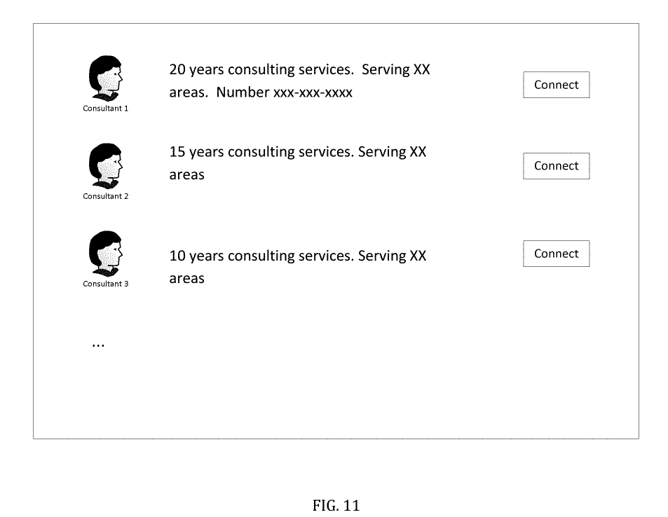

In one example, as illustrated in FIG. 11, a real estate assessment expert can receive and evaluate the real estate assessment report of the target property provided by the user displayed on a display device.

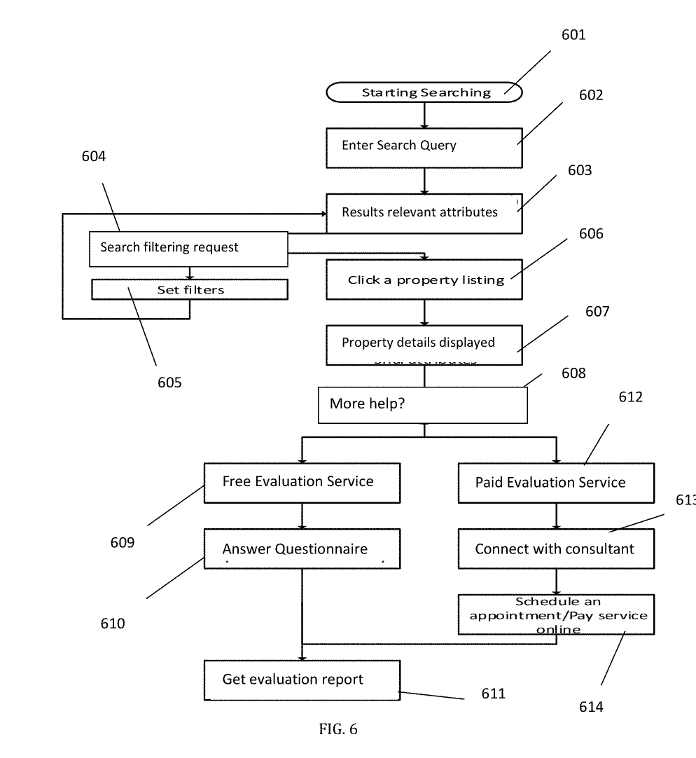

FIG. 6 shows another embodiment of the method of searching for real estate information.

In some embodiments, the user can enter the search query for real estate in the real estate search page, such as “a single house facing towards the south.” Search engines then process the search query, find matching data in the real estate database, and generate search results.

On the search results page, users can use the exclusion option (e.g., filter) associated with the property to further refine the search results. Important information such as address and house area will be listed at the front of the page.

A directional orientation of the property can be listed on the search results page.

Other aspects of the property, if the user uses such search options, can be listed on the search results page; otherwise they are not listed. For example, if the user searches for the distance from a signal tower (i.e., cell tower) at least 30 miles outside the property, then the distance from the signal tower would be listed on the search results page.

In another embodiment, when the curser hovers over a property on a map, information about the property would display in a message box, called a hover box or tooltip.

In the specific real estate information page, all the information about the property will be listed. If users need further assistance they can click on the link or button to enter the free property assessment page or to enter a property assessment page for a fee. The free real estate assessment page provides general comments and general analysis relating to relevant issues (e.g., issues in the study of Feng Shui and the Five Arts of Chinese Metaphysics) pertinent to a particular real estate property. In another embodiment, the free assessment report may even include free advice on how to counteract negative forces identified in those relevant issues.

Additionally or optionally, a property assessment report for a fee can be provided to the user from a professional assessment consultant in the study of Feng Shui or the Five Arts of Chinese Metaphysics. These experts can be linked by the system to provide users with in-depth analysis and recommendation for those users who are in need of such advise.

The flow chart as shown in FIG. 6 includes the following steps:

In step 601, the search is started.

In step 602, the search is entered with the real estate requirements (e.g., Feng Shui preference).

In step 603, search results return which includes the relevant attributes of the property. (e.g., return results with relevant Feng Shui attributes).

In step 604, the system asks whether the user wants to adjust the search results (e.g., redefine the results).

In step 605, the user is to adjust the search results. The user is provided with settings or can adjust the interface; the search is and conducted adjusted search results are obtained.

In step 606, the user no longer adjusts the search result but clicks on a property in the search result.

In step 607, the system shows the detailed data from the user clicking on the selected property. The details include the real estate of the property data (e.g., property details are displayed including the Feng Shui attributes).

In step 608, the user is asked whether a more specialized real estate service is needed.

(e.g., get more Feng Shui help?).

In step 609, the user chooses the free real estate service (e.g., access Feng Shui free evaluation service).

In step 610, the user is presented with an interface for collecting real estate information (e.g., go through Feng Shui questionnaire or survey).

In step 611, the real estate database based on the real estate information collected is compared to the user's answers to the user questionnaire. The system then provides the user a free assessment report.

As an alternative to step 609, in step 612 the user chooses to seek service from an expert (e.g., access Feng Shui paid evaluation service).

In step 613, the user may choose to connect with corresponding real estate experts (e.g. connect with Feng Shui consultants).

In step 614, the user creates an agreement with the expert for his services, or the user completes the online payment at a later time (e.g., schedule an appointment/pay service online). More specifically, payment followed by agreement by the user for the real estate expert's services, or the user can complete the online payment after the User Feedback for Real Estate Assessment Report.

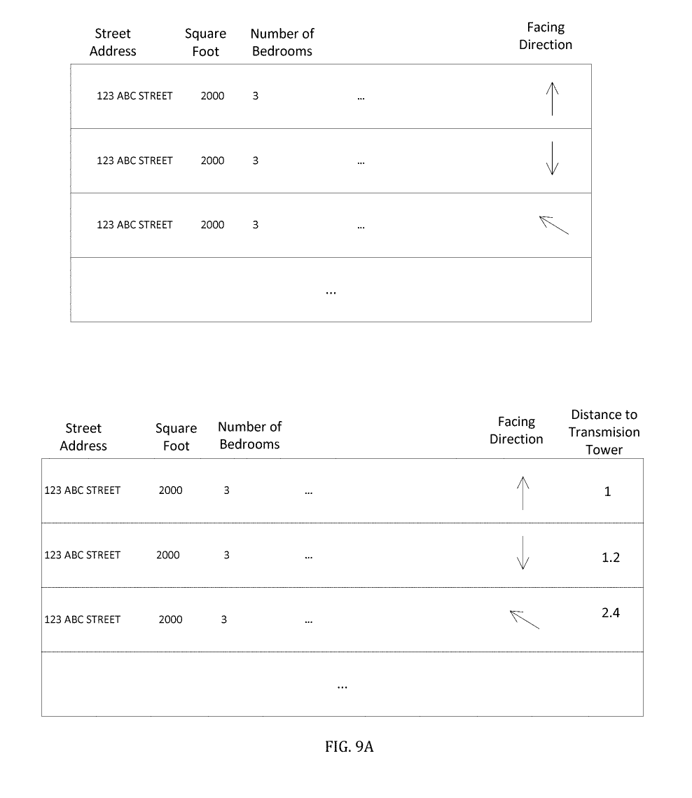

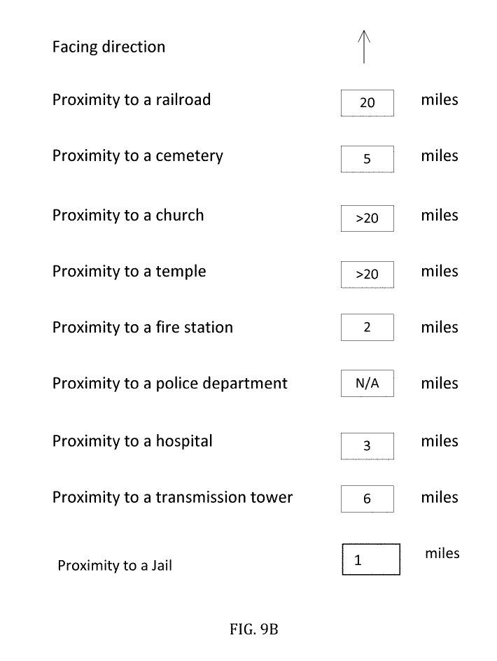

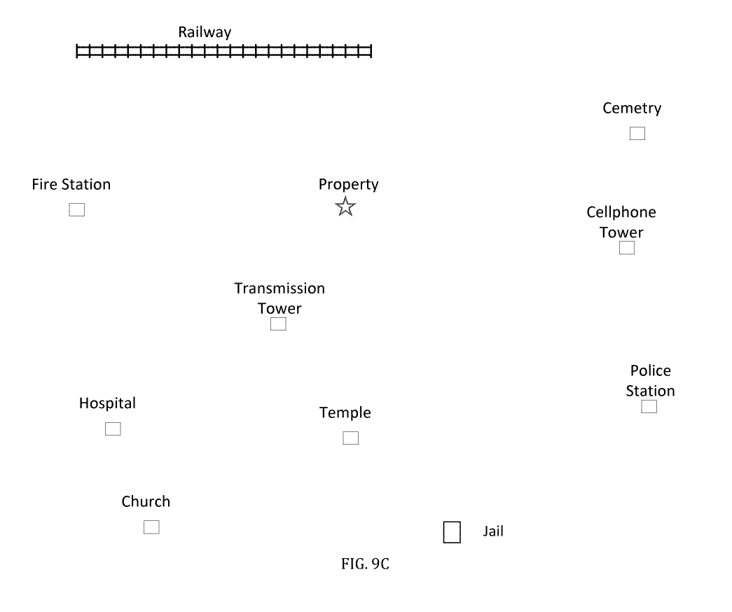

FIG. 9A is a schematic view showing real estate search information in the search interface according to the second embodiment of the present disclosure. On the search results page each property is listed in a box. The direction of the accompanying arrow represents the direction of the property. When the property is displayed on the map, the property shows in a tooltip window.

If the user uses the other properties of the property to search, these property features will also be displayed on the search results page. In the specific real estate page, housing and the distance towards and from the specific establishments or locations will be listed in detail.

FIG. 9B is a schematic view showing a property and a specific transaction distance in the second embodiment of the present disclosure.

In the real estate, for example, do not have customized user inputs for distances from/to, the standard of the body will be used to determine how far away the property, e.g., target property, is from a specific establishment or location, and will display the distance to the user. Uniquely, in order to make informed decisions, a distance of the house from the specific establishment or location has a threshold. If the distance exceeds this threshold, such as 20 miles, this establishment or location will not be displayed. User can change these thresholds based on their specific desires or needs.

FIG. 9C is a schematic diagram showing a target property, e.g., prospective property, and a specific transaction distance in the form of a map in the second embodiment of the present disclosure.

In addition to the specific real estate page, these establishments or locations will be identified on the map.

FIG. 9C shows using this system, the user can easily see and determine the distance of these establishments or locations from the target property, e.g., prospective property.

Advantageously, using this system, a user can obtain more information on a prospective property, and as illustrated in this embodiment, this information can be set on separate single pages or even displayed on different websites.

FIG. 10 shows a questionnaire which the user completes in the second embodiment of the present disclosure.

For example, the questionnaire for a user to fill out could include questions like these: Are the stairs near the main entrance? The user can choose Yes, No, or not applicable. When the questionnaire is completed, the system uses the data in the real estate database as a comparison, and then provides the users with a real estate evaluation report. The user would see all infringements of the real estate the user is considering and could adjust their choices.

For example, based on user inputs into the questionnaire, a mirror facing the main entrance in a single family home could be considered a detriment. The comments from the system would be the correction to remove the mirror.

Advantageously, based on a user's input to the questionnaire, the system provides comments on potential issues and typical opinions about issues, and suggests common solutions like above (remove mirror to maintain a study of Feng Shui for their property).

FIG. 11 is an interface diagram showing real estate experts' contact information in the second embodiment of the present disclosure.

Thus, another service is granted. The user is provided a list of experts that is generated along with their fee requirements.

This service is to acquaint the user with the professional real estate consultants. When the user in the specific real estate page clicks on the relevant button, it will open a real estate assessment, check the service page, and list the professional real estate assessment consultant. The basic information of the consultant can be provided on the page materials, including photos, professional experience, service areas, assessment fees, contact information and so on.

Users can choose, e.g., choose an appropriate appraiser who can be contacted online or invited to the property to do the assessment. Fees, too, can be paid online.

In the present embodiment, the user can obtain professional assistance through the real estate assessment service.

Free Internet system to provide access to obtain either a free or a paid assessment. The free assessment is generated from a questionnaire.

The services for these assessments appear in the form of links on the page of the property. Thus, on the home page of the real estate internet system the user can obtain a professional real estate assessment report. The system has provided both an informative and a convenient service.

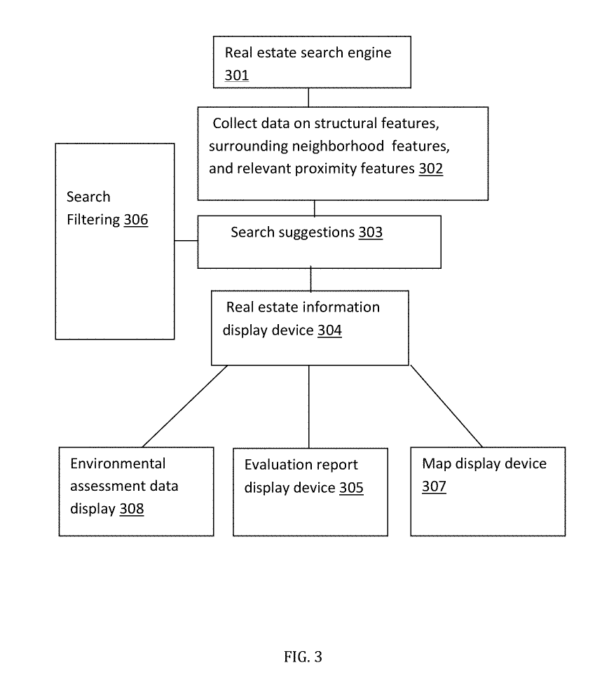

FIG. 3 is a schematic structural view of a system for searching real estate information as described in the third embodiment of the present disclosure.

The system described in the examples is used to implement the method of searching for real estate information as described in the above embodiments.

This implementation system includes a real estate search engine 301, search settings 302, search suggestions 303, a real estate information display device 304, and an evaluation report display device 305.

In FIG. 3A, real estate search request is entered into real estate search engine 301 which is connected to search settings 302 for searching in the system for real estate information, the Structural Features, Surrounding Neighborhood Features, and Relevant Proximity Features of the property, the surrounding data of the property, and relative to the specific establishments or locations of the data. This above information and search settings 302 would be included in the stored real estate database.

Search settings 302 are connected to the real estate search engine 301 and search suggestions 303, which set the Structural Features, Surrounding Neighborhood Features, and Relevant Proximity Features for each search query (based on user input to the questionnaire as discussed previously), the property surrounding data, and the Structural Features, Surrounding Neighborhood Features, and Relevant Proximity Features of the specific establishment or location. These search suggestions are saved to the real estate database.

Search suggestions 303 and search setting 302 and the real estate information display device 304 are for receiving and parsing the real estate search request to obtain a corresponding search query, and the content of the search is compared with the search query in the real estate database. The search query are searched and displayed.

The real estate information display device 304 and the search suggestions 303 and the evaluation report display device 305 connect the selected search suggestions with features in the real estate database.

According to the property surrounding data and relative to the specific establishments or locations of the Structural Features, Surrounding Neighborhood Features, and Relevant Proximity Features comparison, the selected search suggest the same content of the target property, which is then displayed for a user. This user will obtain the information on the target property from the real estate database according to the details of the real estate search request details of the characteristics of the property, the surrounding data of the property, and the Structural Features, Surrounding Neighborhood Features, and Relevant Proximity Features relative to the specific establishment or location.

The evaluation report display device 305 is connected to the real estate information display device 304 for use in conjunction with a real estate assessment request. The information collected is available on the real estate assessment display 308.

In one embodiment, the information collected is compared with a default real estate assessment standard to generate real estate assessment of the target property and displayed on the evaluation report display device 305. In one alternative, a real estate assessment expert analyzes and/or modifies the real estate assessment report of the target property responsive to a user request.

The system further includes a tool for a search filtering request 306. The search suggestions 303 can receive the search filtering request for the search query, and can display all of the search filtering requests according to the search filtering request of the search suggestions, the selected search suggestions and the Structural Features, Surrounding Neighborhood Features, and Relevant Proximity Features, and in the real estate database, the property surrounding data, and the Structural Features, Surrounding Neighborhood Features, and Relevant Proximity Features with respect to selected establishments or locations. Information with the same (similar) content as the selected search suggestions of the target property can be obtained and displayed for a user.

Additionally, the Structural Features, Surrounding Neighborhood Features, and Relevant Proximity Features of the property includes at least one of: the direction of a main entrance and a back door; the direction of a main entrance and a toilet door, and the relationship of a main entrance and a mirror; type of street characteristic (T-junction/intersection or a dead end characteristic); and backyard inclination characteristics; distance from funeral parlors, churches, temples, jails, fire stations, police stations, hospitals, overhead power lines, and cell towers.

The system further includes a map display device 307 and the real estate information display device 304 which together provide a display map of the geographical location of the target property. Structural Features, Surrounding Neighborhood Features, and Relevant Proximity Features of the target real estate, the surrounding data of the property and the the details of the Structural Features, Surrounding Neighborhood Features, and Relevant Proximity Features are shown in the map as well.

The system also includes a real estate assessment data display device 308. The real estate information display device 304 is connected for the Structural Features, Surrounding Neighborhood Features, and Relevant Proximity Features, the property surrounding data and details of Structural Features, Surrounding Neighborhood Features, and Relevant Proximity Features relative to specific establishments or locations.

Another feature of the system is that corresponding property real estate assessment data and the target property assessment data is stored in the real estate database. A user can obtain information on a corresponding property (e.g., neighboring property) from the real estate database based on a request for property assessment data made by a user, such as, a real estate assessment data expert.

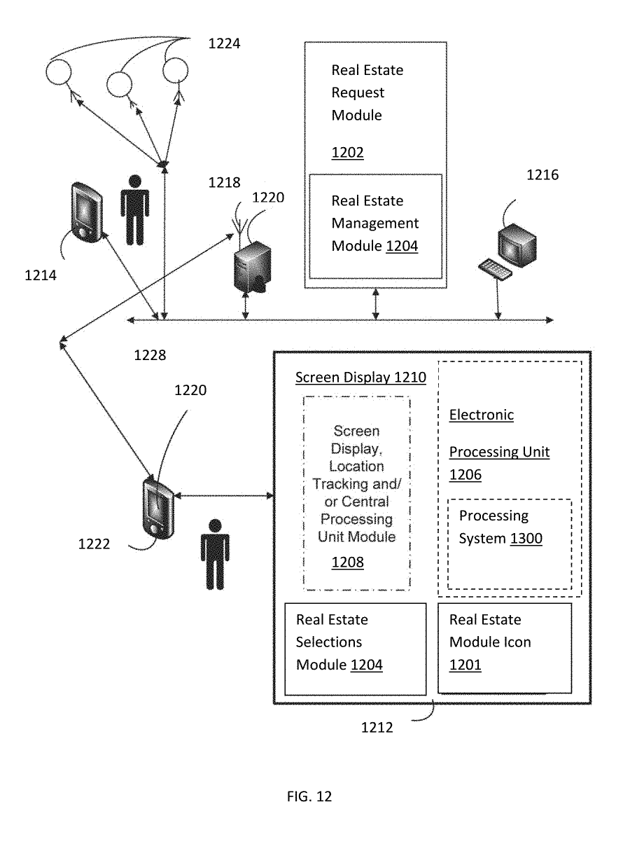

FIG. 12 shows a functional system diagram illustrating real estate module icon 1201 and system 1200 according to embodiments illustrated in FIGS. 1-11 of the present disclosure. System 1200 is a real estate system for a user's mobile phone or computer that modifies by using a request (search request) through real estate request module 1202. Real estate request module 1202 discloses a system that searches for real estate information of a property for a search engine.

In this system, server system 1220 includes: one or more servers which are communicatively coupled to one or more network interfaces to facilitate access to a network. The server system 1220 comprises one or more data stores communicatively coupled to the one or more servers; the one or more data stores storing candidate data for searching real estate information; the one or more servers to:

process transmissions collected by a collecting device and received by the server system 1220; the transmissions are received from an end-user interface 1222, 1214 receives user input for a search device;

display the transmissions on a display device 1212;

display the transmissions on a real estate information display device 1210; and

create an evaluation report display device 1204;

wherein the server is connected to a search setting for the search engine used for searching real estate information, collecting Structural Features, Surrounding Neighborhood Features, and Relevant Proximity Features of the target property, the target property surrounding Structural Features, Surrounding Neighborhood Features, and Relevant Proximity Features and the relative to specific data and all of which is stored in a real estate database;

wherein the search suggestions for the search engine is connected to the transmissions that are collected and search suggestions; the server to set the Structural Features, Surrounding Neighborhood Features, and Relevant Proximity Features of the property, and store a search query to the real estate database 1216;

wherein the search suggestions are connected to the transmissions of the search query and the real estate information 1204 is received and parsed as part of the real estate search request 1222, 1214 and obtain a corresponding search query,

compare the search query with the real estate search request;

compare the search query in the real estate database to obtain a search result corresponding to the search query and display; the real estate information display device is connected with the search suggestions and an evaluation report display device, for the selected search suggestions and the Structural Features, Surrounding Neighborhood Features, and Relevant Proximity Features in the real estate database, and Relevant Proximity Features in the real estate database.

In some embodiments, the system includes obtain the target property from the real estate database 1216 according to details of target property display request details of the Structural Features, Surrounding Neighborhood Features, and Relevant Proximity Features of the target property relative to the specific contents and display on the device;

In some embodiments, wherein an evaluation report display device is connected to the real estate information display device, an assessment request shows the real estate assessment of the information collection display interface collected of target real estate information to produce and evaluate the real estate assessment report of the target real estate in contrast a default real estate assessment criteria. In one further example, according to the request of the real estate assessment report connected to the real estate assessment report, receive from the real estate assessment report of the target property a real estate assessment on a display device.

In some embodiments, a search filtering request connected to the search suggestions, the search filtering request receives the search query and presents all the search suggestions according to the search filtering request; selects the search suggestions with the one or more real estate features of the real estate database of the target property including the Structural Features, the Surrounding Neighborhood Features, and the Relevant Proximity Features of the target property are compared with the search query and shows specific contents of the target property on a display device.

In some embodiments, wherein the Structural Features includes at least one of: a real estate orientation, stairs towards a main entrance and a back door, a relationship between a front door and a bathroom door and an orientation of a main entrance and a mirror. In one further example, the Surrounding Neighborhood Features includes at least: type of street characteristic, including dead-end characteristic; backyard of a slope characteristic. In one further example, the Relevant Proximity Features relative to a selected establishments and locations includes a distance from at least one of a train station, a jail, a funeral home, a church, a temple, a fire station, a police station, a hospital, a signal tower and a mobile phone signal station.

In some embodiments, the system includes a map display connected to the real estate information display, the map display includes a geographical location of the target property, a display place of the target property based on a geographical location that compares the Structural Features, Surrounding Neighborhood Features, and Relevant Proximity Features of the target property, and results are proximity on a map.

In some embodiments, the system includes the real estate assessment data display device is connected to the real estate information display device and is provided for each of the details of Structural Features, Surrounding Neighborhood Features, and Relevant Proximity Features, and Relevant Proximity Features relative to specific real estate features. In one further example, the real estate assessment data display device stores a real estate assessment data to the real estate database; and obtains the target property from the real estate database based on assessment request for display on a display device.

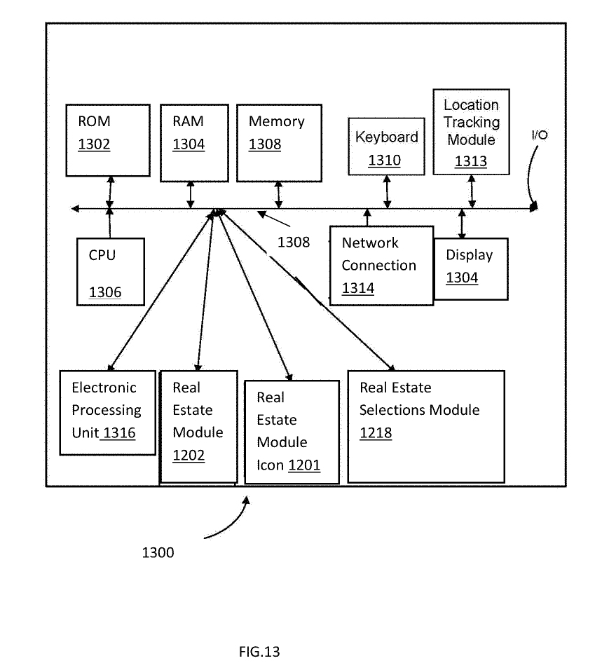

FIG. 13 illustrates a block diagram 1300 of processing systems 1301, 1302 illustrating interaction between mobile software module 1201, 1202, 1218 and mobile device 1214, 1222 according to an embodiment of the present disclosure of FIGS. 1-12.

Referring to FIG. 13, device(s) connect(s) to a network include a processing system 1300. Processing system 1300 has a central processing unit (CPU) 1306 that may be a processor, microprocessor, or any combination of processors and microprocessors that execute instructions stored in memory to perform an application. CPU 1306 connects memory bus and Input/Output bus. A non-volatile memory, such as, Read Only Memory (ROM) 1302 is connected to CPU 1306 via memory bus 1308. ROM 1304 stores instructions for initialization and other systems command Volatile memory such as Random Access Memory (RAM) 1304, for example, DRAM, and/or SDRAM, connects to CPU 1306 via memory bus 1308. RAM, DRAM, SDRAM or the like stores instructions for processes that are executed and data operated on by one or more executed processes. Peripheral devices include memory, display, I/O device, and network connection device connected to CPU 1306 via I/O bus. I/O bus carries data between user mobile device 1306, e.g., real estate module 1202, real estate module icon 1201, electronic processing unit 1316, and real estate selections 1218, and the like, the CPU 1306, Memory, e.g., read/write compact discs (CDs) and magnetic disk drives, and stores data onto a media. Display 1304 is a monitor and/or display and associated drivers, including electronic drivers and electronic modules, convert data to a display. I/O device is a keyboard, a pointing device or other device that may be used by a user to input data. Network device is a modem or Ethernet that connects processing system 1300 to a network connection 1314 and/or location tracking module 1313 and/or keyboard 1310.

As can be seen from the above-described embodiments, the method and system for searching real estate information using the present disclosure include the following benefits:

The system integrates the real estate into the real estate Internet system so that users can inquire about real estate that corresponds to their personal needs and tastes; the system provides information relevant to the target property including information about the surrounding and outlying areas; the system can provide the user with professional real estate peripheral services which would give more accurate and comprehensive real estate information; the system is entirely personalized to a user's needs; the system determines the user's own preferences and requirements and lists the basic attributes of properties that match the user's standards; the system offers the user convenience and guidance in searching for a property; the system provides a professional real estate assessment which can be used to seek out further professional advice or help; the system allows the user to quickly and easily connect with a real estate professional; and the system allows for easy Internet payment of the professional.

It will be understood by those skilled in the art that embodiments of the present disclosure may be provided as a method, apparatus, and computer program products.

Accordingly, the present disclosure may employ a complete hardware embodiment, or a combination a complete software embodiment, or a combination. Moreover, the present disclosure may be employed in one or more computer-usable storage media containing computer-usable program code (including but not limited to disk storage, CD-ROM, optical memory, etc.) in the form of computer program products.

While some specific embodiments of the present disclosure have been described in detail by way of example, it should be understood by those skilled in the art that the foregoing examples are provided for purposes of illustration only and are not intended to limit the disclosure or the range.

It will be understood by those skilled in the art that various changes may be made without departing from the scope and spirit of the disclosure, the above embodiment is modified. The scope of the disclosure is defined by the appended claims.

It should be noted as herein described that the steps and/or method of contemplated use can be carried out in many different ways, procedures, and the like according to, for example, one or more user preference(s). “[S]tep of” should not be interpreted as “step for”, in the claims herein and is not intended to invoke the provisions of 35 U.S.C. §112, ¶6.

Upon reading this specification, it should be appreciated that, under appropriate circumstances, considering such issues as user requirements or wishes, design considerations, marketing preferences, cost(s), structural requirement(s), available materials, technological advances, etc., other methods of use arrangements such as, for example, orders within the above-mentioned list that are different, eliminated and/or require additional steps, including or eliminating, for example, procedure, process, and/or maintenance step(s), etc., may be sufficient.

Many alterations and modifications may be made by those having ordinary skill in the art without departing from the spirit and scope of the disclosure. Therefore, it must be understood that the illustrated embodiments have been set forth only for the purposes of example and that they should not be taken as limiting the disclosure.

The words used in this specification to describe the disclosure and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use must be understood as being generic to all possible meanings supported by the specification and by the word itself.

The definitions of the words or elements therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements or that a single element may be substituted for two or more elements. Although elements may be described above as acting in certain combinations, it is to be expressly understood that one or more elements from a certain combination can in some cases be excised from the combination and that the combination may be directed to a subcombination or variation of a subcombination.

Thus, specific embodiments and applications of searching real estate information have been disclosed. It should be apparent, however, to those skilled in the art that many more modifications besides those already described are possible without departing from the inventive concepts herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the subject matter as viewed by a person with ordinary skill in the art, now known or later devised, are expressly contemplated as an equivalent. Therefore, obvious substitutions now or later known to one with ordinary skill in the art are defined to be within the scope of the defined elements.

I claim:

1. A method of searching real estate information of a property for a search engine, comprising:
processing, by a computing system, a first set of transmissions from an end-user device and received by a server system, the first set of transmissions including a real estate search request of the property including Structural Features, Surrounding Neighborhood Features, and Relevant Proximity Features of the property to one or more real estate features stored in a real estate database;
processing information, by the computing system, the Structural Features, the Surrounding Neighborhood Features, and the Relevant Proximity Features of the property for each search suggestion, and identifying one or more properties by the Structural Features, the Surrounding Neighborhood Features, and the Relevant Proximity Features of the property, and stores the search suggestions to a real estate database;
receiving and parsing, by the computing system, the real estate search request to obtain a search query, and comparing the search query at least partially based on the real estate search request; and
comparing, by the computing system, the search query to a default search query in the real estate database, and obtaining the results of a target property corresponding to the search query.

2. The method of claim 1, comprising the steps of:
obtaining, by the computing system, a request for a detailed description of the target property; and
displaying, by the computing system, the results with the Structural Features, the Surrounding Neighborhood Features, and the Relevant Proximity Features of or more real estate features in the real estate database.

3. The method for searching real estate information according to claim 2, comprising the steps of:
according to a real estate assessment request, showing, by the computing system, a real estate assessment on an information collection interface; and
comparing, by the computing system, detailed description of the target property with a default real estate assessment criteria.

4. The method for searching real estate information according to claim 3, comprising the steps of:
generating, by the computing system, a target property real estate assessment report; and
displaying according to the real estate assessment request connected to a real estate assessment, and received from the target property real estate assessment report of the target property of the real estate assessment request.

5. The method for searching real estate information according to claim 1, further comprising, by the computing system, the following steps:
receiving a search filtering request for the search query;
presenting all searches of the search query according to the search filtering request;
selecting the one or more real estate properties in the real estate database of the target property including the Structural Features, Surrounding Neighborhood Features, and Relevant Proximity Features relative to a specific criteria are compared with the search suggestion of the search query of the target property.

6. The method for searching real estate information according to claim 1, further comprising, by the computing system, the following steps:
processing, by the computing device, the Structural Features that illustrates specific contents of the target property including: a real estate orientation, stairs towards a main entrance and a back door; a relationship between a front door and a bathroom door and an orientation of a main entrance and a mirror; the Surrounding Neighborhood Features including at least one or more of the following: type of street characteristic, including dead end characteristic; backyard slope characteristic; and the Relevant Proximity Features including a distance from at least one of a train station, a jail, a funeral home, a church, a temple, a fire station, a police station, a hospital, a signal tower and a mobile phone signal station.

7. The method for searching real estate information according to claim 4, comprising steps of:
obtaining a geographical location of the target property;
generating the target property based on the geographic location on a display map; and
generating the Structural Features, Surrounding Neighborhood Features, and Relevant Proximity Features of the target property, and
showing details of the Structural Features, Surrounding Neighborhood Features, and Relevant Proximity Features on a display map.

8. The method for searching real estate information according to claim 4, comprising the steps of:
for each of specific details of the Structural Features, Surrounding Neighborhood Features, and Relevant Proximity Features of the target property;
preparing a corresponding real estate assessment data;
saving the real estate assessment data to the real estate database;
obtaining a corresponding real estate assessment report of the property based on a request for the real estate property assessment data;
providing a questionnaire to a user that asks specific questions relating to the target property; and
outputting from the questionnaire comments and typical opinions on potential issues.

9. A system for searching for searching real estate information of a property for a search engine, comprising:
a server system comprising one or more servers communicatively coupled to one or more network interfaces to facilitate access to a network, the server system comprising one or more data stores communicatively coupled to the one or more servers, the one or more data stores storing candidate data for searching real estate information, the one or more servers to:
process transmissions collected by a collecting device and received by the server system, the transmissions are received from an end-user interface as user input for a search device;
display the transmissions on a display device;
display the transmissions on a real estate information display device; and
create an evaluation report display device;
wherein, the server is connected to a real estate search request for the search engine for searching for real estate information, collecting Structural Features, Surrounding Neighborhood Features, and Relevant Proximity Features of a property, and relative to specific data and stored in a real estate database;
wherein the search suggestions for the search engine is connected to the transmissions that are collected and search suggestions, set the search property to set the Structural Features, Surrounding Neighborhood Features, and Relevant Proximity Features of the property, and storing search query to the real estate database;
wherein the search suggestions are connected to the transmissions of the search query and the real estate information received and parsed as part of the real estate search request and obtain a corresponding search query, compare the search query with the real estate search request;
compare the search query of the real estate database to obtain results corresponding to the search query on a real estate display device; the real estate display device is connected with the search suggestions and an evaluation report display device, for the search suggestions and the search suggestions of the target property that illustrates specific contents of the target property including the Structural Features, Surrounding Neighborhood Features, and Relevant Proximity Features in the real estate database.

10. The system for searching for real estate information according to claim 9, further comprising:
obtain the target property from the real estate database according to details of target property from the one or more real estate features in the real estate database including the Structural Features, Surrounding Neighborhood Features, and Relevant Proximity Features of the target property relative to the specific contents and display the result on a display device.

11. The system for searching for real estate information according to claim 9, further comprising:
wherein an evaluation report display device is connected to the real estate information display device, an assessment request shows the real estate assessment of the information collection display interface collected of target real estate information to produce and evaluate the real estate assessment report of the target real estate in contrast to a default real estate assessment criteria; and
according to the request of the real estate assessment report connected to the real estate assessment report, receive from the real estate assessment report of the target property a real estate assessment on a display device.

12. The system for searching for real estate information according to claim 11, further comprising:
a search filtering request connected to the search suggestions, the search filtering request receives the search query and presents all the search suggestions according to the search filtering request; selects the search suggestions with the one or more real estate features of the real estate database of the target property including the Structural Features, the Surrounding Neighborhood Features, and the Relevant Proximity Features of the target property are compared with the search query and shows specific contents of the target property on a display device.

13. The system for searching for real estate information according to claim 12, wherein the Structural Features includes at least one of: a real estate orientation, stairs towards a main entrance and a back door, a relationship between a front door and a bathroom door and an orientation of a main entrance and a mirror; the Surrounding Neighborhood Features includes at least: type of street characteristic, including dead-end characteristic; backyard of a slope characteristic; and the Relevant Proximity Features relative to a selected establishments and locations includes a distance from at least one of a train station, a jail, a funeral home, a church, a temple, a fire station, a police station, a hospital, a signal tower and a mobile phone signal station.

14. The system for searching for real estate information according to claim 13, comprising:
a map display connected to the real estate information display, the map display includes a geographical location of the target property, a display place of the target property based on a geographical location that compares the Structural Features, Surrounding Neighborhood Features, and Relevant Proximity Features of the target property, and results are proximity on a map.

15. The system for searching for real estate information according to claim 14, comprising:
the real estate assessment data display device is connected to the real estate information display device and is provided for each of the details of Structural Features, Surrounding Neighborhood Features, and Relevant Proximity Features, and Relevant Proximity Features relative to specific real estate features, wherein the real estate assessment data display device stores a real estate assessment data to the real estate database; and obtains the target property from the real estate database based on real estate assessment request for display on a display device.
